(19) United States
(12) Patent Application Publication
(10) Pub. No.: US 2007/0243868 A1
(43) Pub. Date: Oct. 18, 2007

(54) System and Method for Enhanced Community Alarming

(75) Inventor: Robert C. Lovell, Leesburg, VA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/735,781

(22) Filed: Apr. 16, 2007

Related U.S. Application Data
(60) Provisional application No. 60/792,352, filed on Apr. 17, 2006.

(51) Int. Cl. H04Q 7/20

(52) U.S. Cl. 455/433

(57) ABSTRACT

A service that leverages established wireless messaging paradigms such as, possibly inter alia, Short Message Service and Multimedia Message Service to allow Mobile Subscribers to use their Wireless Devices to fully interoperate with Community Alarm, and other similarly-situated, facilities. The service may optionally leverage the capabilities of a Messaging Inter-Carrier Vendor.

This application claims the benefit of U.S. Provisional Patent Application No. 60/792,352, filed on Apr. 17, 2006, which is herein incorporated by reference in its entirety.

### BACKGROUND

1. Field of the Invention

The present invention relates generally to telecommunications services. More particularly, the present invention relates to capabilities that enhance substantially the value and usefulness of various wireless messaging paradigms including, inter alia, Short Message Service (SMS), Multimedia Message Service (MMS), IP Multimedia Subsystem (IMS), etc.

2. Background of the Invention

As the ‘wireless revolution’ continues to march forward the importance to a Mobile Subscriber (MS), for example a user of a Wireless Device (WD) such as a mobile telephone, BlackBerry, etc. that is serviced by a Wireless Carrier (WC), of their WD grows substantially while, simultaneously, the challenges that are associated with offering to MSs new and useful services, particularly within a truly ubiquitous cross-WC environment, similarly increase.

Further, as the ‘aging of America’ progresses and the number of elderly members of society continues to increase additional, and new, needs within that group are constantly arising. Among other things, as many people find themselves living longer they are striving to live independently for as long a period of time as possible (before, for example, they must transition to some form of assisted-living facility). To aid that goal, i.e., of living independently for as long as possible, a wide range of support services have arisen. One such class of service is the Community Alarm (CA) service.

CA services, such as the popular Lifeline service that is offered by Lifeline Systems, Inc. (a division of Philips), provide mechanisms through which an “individual may . . . summon assistance to their location” in case of, for example, an emergency. For example, under the Lifeline service a Personal Help Button may be worn around one's neck, on one's wrist, etc. and in case of an emergency or other need one need “simply press the Personal Help Button and Lifeline's emergency response service goes into action” to deliver the required assistance. Typically, the personal Help button is associated with a low power transmitter that sends a signal to a receiver (or transceiver), which then sends a signal, alarm, etc. to an appropriate service provider.

The present invention extends key elements of wireless technology to allow MSs to more fully interoperate with CA (and other similarly-situated) services and addresses various of the (not insubstantial) challenges that are associated with same.

### SUMMARY OF THE INVENTION

Embodiments of the present invention provide mechanisms through which a MS′ WD may be utilized to fully interoperate with Community Alarm, and other similarly-situated, facilities.

In one embodiment, a method for community alarming includes receiving from a Service Device an indication of an alarm condition; performing one or more processing steps on said indication using at least in part information previously supplied by a Mobile Subscriber; generating a notification message in view of the processed indication; and dispatching said notification message to a Wireless Device of said Mobile Subscriber, wherein said alarm condition is initiated by someone other than said Mobile Subscriber.

In an aspect of this and other embodiments said information is defined by a Mobile Subscriber during a registration process, and the information may include at least one of Identifying Information, Subject Information, Contact Information, and Billing Information. The information may further be preserved through a User Profile.

In another aspect of this and other embodiments the registration process is Web-based, and may include a billing component.

In a preferred implementation the notification message is a SMS message or a MMS message, and may contain advertising and/or promotional material.

In an embodiment, a fee is charged for notification service.

The method of this and other embodiments may further include receiving a reply from said Mobile Subscriber; processing said reply resulting in a processed reply; and conditionally communicating with said Service Device in view of the processed reply. The method may still further include dispatching another notification message to a first responder.

In the method, the Service Device may be augmented with manual or automatic control capabilities, wherein the automatic control means includes voice recognition or presentation software. The Service Device may also be augmented with multimedia capabilities.

The method may also include determining whether a reply has been received from said Mobile Subscriber and dispatching another notification message to another Mobile Subscriber.

In another embodiment, a method includes receiving information from a Mobile Subscriber during a registration process, the information including an identification of a Service Device that is operable by someone other than the Mobile Subscriber and further including a telephone number of a mobile device used by the Mobile Subscriber, and a telephone number of another mobile device used by someone other than the Mobile Subscriber; receiving from the Service Device an indication of an alarm condition; processing said indication using at least in part the information received during the registration process; generating a first notification message; dispatching said first notification message to the telephone number received as part of the information received during the registration process; generating a second notification message; and dispatching said second notification message to said telephone number of another mobile device used by someone other than the Mobile Subscriber.

The first and second notification messages may be SMS messages or MMS messages.

Stated alternatively, in embodiments of the invention a SP (1) receives from a Service Device (SD) an indication of an alarm condition, (2) performs one or more processing steps on said indication using at least in part information previously supplied by a MS, (3) conditionally generates one or more notification messages, and (4) dispatches said notification messages to a WD of said MS.

In the foregoing process, a SP may also (1) receive a reply from a MS, (2) process said reply, and (3) conditionally communicate with said SD in view of the processed reply.

The above process may further include a first responder injection capability, and the SD may be augmented with manual (e.g., human intervention) or automatic (e.g., voice recognition and/or presentation software) control capabilities and/or multimedia capabilities.

These and other features of the embodiments of the present invention along with their attendant advantages will be more fully appreciated upon a reading of the following detailed description in conjunction with the associated drawings.

### BRIEF DESCRIPTION OF THE DRAWINGS

FIG. 1 is a diagrammatic presentation of an exemplary Messaging Inter-Carrier Vendor (MICV).

FIG. 2 illustrates various of the exchanges or interactions that are supported by aspects of the present invention.

FIG. 3 illustrates further of the exchanges or interactions that are supported by aspects of the present invention.

FIG. 4 is a diagrammatic presentation of aspects of an exemplary Service Provider (SP) Application Server (AS).

### DETAILED DESCRIPTION OF THE INVENTION

Embodiments of the present invention may leverage the capabilities of a centrally-located, full-featured MICV facility. Reference is made to U.S. Pat. No. 7,154,901 entitled “INTERMEDIARY NETWORK SYSTEM AND METHOD FOR FACILITATING MESSAGE EXCHANGE BETWEEN WIRELESS NETWORKS,” and its associated continuations, for a description of a MICV, a summary of various of the services/functions/etc. that are performed by a MICV, and a discussion of the numerous advantages that arise from same.

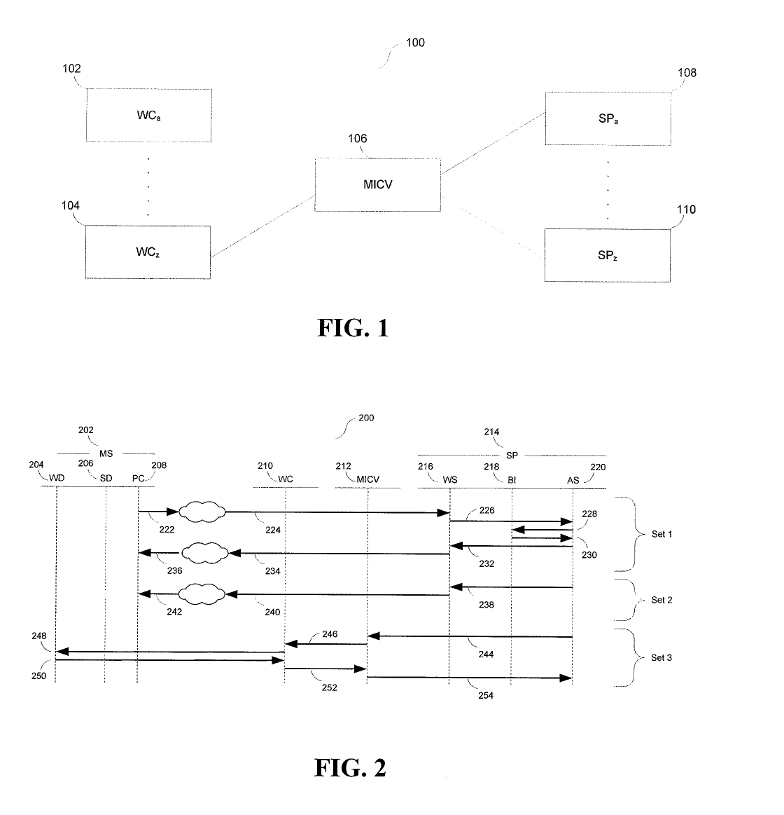

As depicted in FIG. 1 and shown generally by 100, a MICV 106 may be disposed between, possibly inter alia, multiple WCs (WCₐ 102→WC_{z} 104) on one side and multiple SPs (SPₐ 108→SP_{z} 110) on the other side thus ‘bridging’ all of the connected entities. A MICV thus, as one simple example, may offer various routing, formatting, delivery, value-add, etc. capabilities that provide, possibly inter alia:

1) A WC (and, by extension, all of the MSs that are serviced by the WC) with ubiquitous access to a broad universe of SPs, and

2) A SP with ubiquitous access to a broad universe of WCs (and, by extension, to all of the MSs that are serviced by the WCs).

While the discussion below will include a MICV, it will be readily apparent to one of ordinary skill in the relevant art that other arrangements are equally applicable and indeed are fully within the scope of the present invention.

In the discussion below the present invention is described and illustrated as being offered by a SP. A SP may, for example, be realized as a third-party service bureau, an element of a WC or a landline carrier, an element of a MICV, multiple third-party entities working together, etc.

In the discussion below reference is made to messages that are sent, for example, between a MS and a SP. As set forth below, a given ‘message’ sent between a MS and a SP may actually comprise a series of steps in which the message is received, forwarded and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SPₓ offers a CA service that has been enhanced or augmented as provided through aspects of the instant invention and Mary, a MS, uses SPₓ's service.

FIG. 2 and reference numeral 200 illustrate various of the exchanges or interactions that might occur under a portion of our hypothetical example. Of interest and note in the diagram are the following entities:

MS 202 WD 204. For example, Mary's WD such as mobile telephone, BlackBerry, PalmPilot, etc.

MS 202 Service Device (SD) 206. For example, a box or device that is supplied by SPₓ 214 and which may communicate at least with SPₓ 214 through any number of mechanisms (including, inter alia, wireless or wireline telephone, cable TV, satellite, etc.) or a suitably-capable Personal Video Recorder (PVR)/Digital Video Recorder (DVR) or a suitably-capable television set-top box or a suitably-capable Personal Computer (PC), etc. SD 206 may, for instance, be a receiver (or transceiver) that operates in conjunction with the “Personal Help Button” as described previously herein.

MS 202 PC 208. For example, one of Mary's home, work, etc. PCs.

WC 210. The provider of service for Mary's WD 204.

MICV 212. As noted above the use of a MICV, although not required, provides significant advantages.

SP 214 Web Server (WS) 216. A publicly-available Web site that is optionally provided by SPₓ 214.

SP 214 Billing Interface (BI) 218. A single, consolidated interface that SPₓ 214 may use to easily reach, inter alia, one or more external entities such as a credit card or debit card clearinghouse, a carrier billing system, a service bureau that provides access to multiple carrier billing systems, etc.

SP 214 AS 220. Facilities that provide key elements of the instant invention (which will be described below).

It is important to note that while in FIG. 2 the MS 202 WD 204, MS 202 SD 206, and MS 202 PC 208 entities are illustrated as being adjacent or otherwise near each other, in actual practice the entities may, for example, be physically located anywhere. As just one possible example, Mary's PC (MS 202 PC 208) may reside in Mary's residence but she may place a SD (MS 202 SD 206) in her elderly relative's residence.

In FIG. 2 the exchanges that are collected under the designation Set 1 represent the activities that might take place as Mary 202 completes a registration process with SPₓ 214:

A) Mary 202 uses one of her PCs 208 to visit SPₓ's 214 WS 216 to, possibly among other things, complete a service registration process (222→224).

B) SPₓ's 214 WS 216 interacts with SPₓ's 214 AS 220 to, possibly among other things, commit some or all of the information that Mary 202 provided to a data repository (e.g., a database), optionally complete a billing transaction, etc. (226).

C) As appropriate and as required BI 218 completes a billing transaction (228→230).

D) SPₓ's 214 WS 216 responds appropriately (e.g., with the presentation of a confirmation message, etc.) (234→236).

The specific exchanges that were described above (as residing under the designation Set 1) are illustrative only and it will be readily apparent to one of ordinary skill in the relevant art that numerous other exchanges are easily possible and indeed are fully within the scope of the present invention. As just one example, the registration process may be completed through any combination of one or more channels including, inter alia, the World Wide Web (WWW via, for example, a Web site that is operated by SPₓ), wireless messaging (SMS, MMS, etc.), e-mail messages, conventional mail, telephone, Interactive Voice Response (IVR) facility, etc.

During the registration process described above a range of information may be captured from a MS including, inter alia:

A) Identifying Information. For example, possibly among other things, name, address, landline and wireless telephone numbers, e-mail addresses, instant messenger names/identifiers, a unique identifier and a password, etc.

B) Subject Information. For example, information on individuals who are to be monitored/supported including, possibly among other things, name, age, location, contact details, doctor information, medical condition information, etc.

C) Contact Information. For example, possibly among other things, contact details (including, e.g., name, telephone numbers, etc.) for the individuals who may be contacted should (e.g., in the case of an emergency) a monitored/supported subject require assistance.

D) Billing Information. Different service billing models may be offered including, inter alia, a fixed one-time charge, a recurring (monthly, etc.) fixed charge, a recurring (monthly, etc.) variable charge, etc. Different payment mechanisms may be supported including, possibly among other things, credit or debit card information, authorization to place a charge on a MS's phone bill, etc.

The specific pieces of information that were described above are illustrative only and it will be readily apparent to one of ordinary skill in the relevant art that numerous other pieces of information (e.g., additional Subject Information, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database) and may optionally be organized as a MS Profile.

The content of Mary's profile may be augmented by SPₓ to include, as just a few examples of the many possibilities, internal and/or external demographic, psychographic, sociological, etc. data.

As noted above, a SP's BI may optionally complete a billing transaction. The billing transaction may take any number of forms and may involve different external entities (e.g., a WC's billing system, a carrier billing system service bureau, a credit or debit card clearinghouse, etc.). The billing transaction may include, inter alia:

1) The appearance of a line item charge on the bill or statement that a MS receives from her WC. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card.

In FIG. 2 the exchanges that are collected under the designation Set 2 represent the activities that might take place as SPₓ 214 dispatches to Mary 202 one or more confirmation e-mail messages (238→242).

The specific exchanges that were described above (as residing under the designation Set 2) are illustrative only and it will be readily apparent to one of ordinary skill in the relevant art that numerous other exchanges are easily possible and indeed are fully within the scope of the present invention.

In FIG. 2 the exchanges that are collected under the designation Set 3 represent the activities that might take place as SPₓ's 214 AS 220 dispatches one or more confirmation SMS, MMS, etc. messages to Mary's 202 WD 204 (244→248) and Mary 202 replies or responds to the message(s) (250→254).

In the instant example the messages are shown traversing a MICV 212.

The SP 214 may employ a Short Code (SC) or a regular Telephone Number (TN) as its source address (and to which it would ask users of its service to direct any reply messages). While the abbreviated length of a SC (e.g., five digits for a SC administered by Neustar under the Common Short Code [CSC] program) incrementally enhances the experience of a MS 202 (e.g., the MS 202 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “UNIVERSAL SHORT CODE ADMINISTRATION FACILITY.”

Although not explicitly indicated in FIG. 2, a SP 214 may optionally dispatch one or more test messages to a SD 206.

The specific exchanges that were described above (as residing under the designation Set 3) are illustrative only and it will be readily apparent to one of ordinary skill in the relevant art that numerous other exchanges are easily possible and indeed are fully within the scope of the present invention.

The Set 1, Set 2, and Set 3 exchanges that were described above are illustrative only and it will be readily apparent to one of ordinary skill in the relevant art that numerous other exchanges are easily possible and indeed are fully within the scope of the present invention.

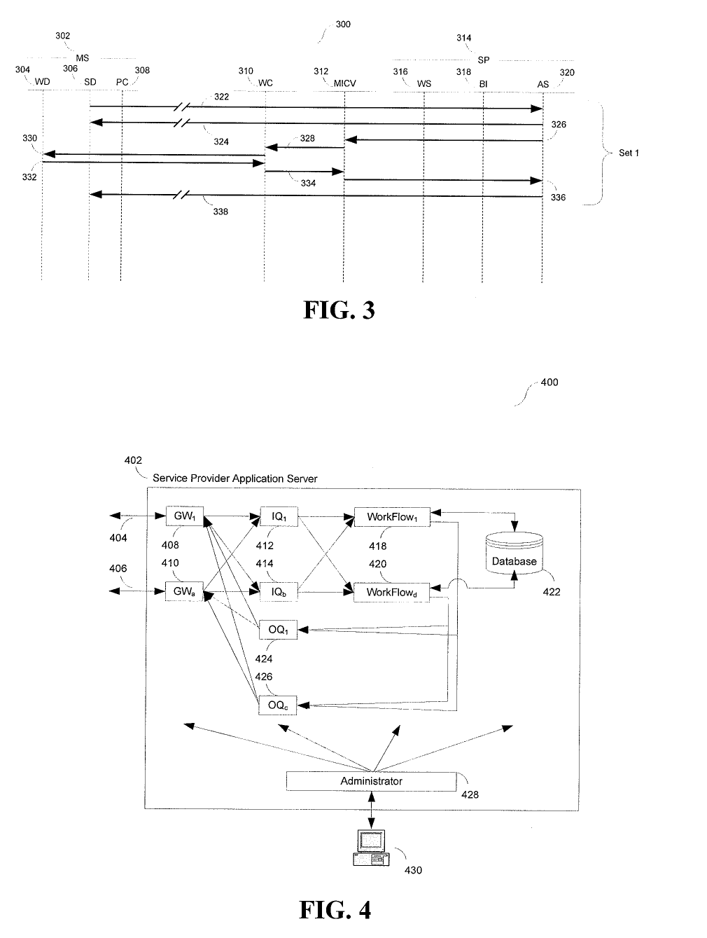

To continue with our hypothetical example . . . In the event of an emergency situation or some other circumstance under which assistance is required, a SD is activated. FIG. 3 illustrates various of the exchanges or interactions that might occur under this aspect of our hypothetical example. The entities that are depicted in FIG. 3 are the same as were depicted in, and described for, FIG. 2.

In FIG. 3 the exchanges that are collected under the designation Set 1represent the activities that might take place as one of Mary's 302 SDs 306 is activated and SPₓ 314 responds. For example:

A) One of Mary's 302 SDs 306 is activated and, possibly inter alia, communicates same to SPₓ's 314 AS 320 (322). This activation may have been initiated by someone other than Mary herself.

B) SPₓ's 314 AS 320 optionally responds to the activated SD 306 (324).

C) SPₓ's 314 AS 320 dispatches one or more notification SMS, MMS, etc. messages to Mary's 302 WD 304 (326→330) and Mary 302 optionally replies or responds to the message(s) (332→336). As before, in the instant example the messages are shown traversing a MICV 312.

D) SPₓ's 314 AS 320 optionally responds to the activated SD 306 (338).

It is important to note that activities C→D just described may optionally be repeated any number of times.

A SP's AS may optionally dispatch one or more notification SMS, MMS, etc. messages to other WDs (e.g., that were identified during the registration process). A SP's iteration through a list of identified WDs may optionally be controlled by, for example, the receipt of a WD reply or response—e.g., a SP may continue to iterate though a list of identified WDs (dispatching notification SMS, MMS, etc. messages) until a response is received from any WD, one or more specific WDs, etc.

A SP may offer any number of enhancements to the basic service, some or all of which may have an associated additional (incremental) fee or charge. For example, inter alia:

1) After a SD is activated one or more keywords, codes, etc. may be spoken and subsequently utilized by the SP, through for example manual means (e.g., human intervention) or automated means (e.g., voice recognition software), to control the content, recipients, etc. of generated notification SMS, MMS, etc. messages. Such an exchange may optionally be repeated any number of times.

2) After a SD is activated a message may be spoken and subsequently converted by the SP, through for example manual means (e.g., human intervention) or automated means (e.g., voice recognition software), to text and included in generated notification SMS, MMS, etc. messages. The content or body of a WD reply or response may optionally be converted by the SP, through for example manual means (e.g., human intervention) or automated means (e.g., voice recognition software), to audio and presented through the SD. Such an exchange may optionally be repeated any number of times.

3) If a SD is suitably equipped then after a SD is activated a SP may capture one or more images, streaming video, audio, etc. that is/are subsequently included in generated notification (e.g., MMS) messages. A SP or MICV may optionally de-tune a generated notification message (e.g., from a MMS message to a SMS message) if it identifies (e.g., possibly through information that was supplied during the registration process) a recipient WD as not being capable of receiving, displaying, etc. the included content.

4) A SP may generate one or more notification SMS, MMS, etc. messages on a scheduled basis (e.g., possibly as defined by a MS during the registration process) that provide a range of status, update, reminder, etc. information.

The enhancements that were described above are illustrative only and it will be readily apparent to one of ordinary skill in the relevant art that numerous other exchanges are easily possible and indeed are fully within the scope of the present invention.

A SP may optionally provide a first responder, etc. injection capability wherein communication with a police officer, fireman, paramedic, doctor, nurse, etc. may be injected or inserted into any of the exchanges or interactions that were described above. More specifically, a notification message may not only be dispatched to Mary's WD, but may also be dispatched to appropriate authorities via any number of paths, including wireless and wireline paths including, e.g., email, SMS, MMS, text to speech, etc.

The confirmation, notification, etc. message(s) that were described above may optionally contain an informational element—e.g., a relevant or applicable factoid about a specific drug, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text that is selected from a pool of available informational text based on the current physical location of the recipient of the message as derived from, as one example, a Location-Based Services [LBS] facility).

The confirmation, notification, etc. message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The confirmation, notification, etc. message(s) may optionally contain promotional materials (e.g., still images, video clips, etc.).

FIG. 4 provides a diagrammatic presentation of aspects of an exemplary SP AS 402. The illustrated AS 402 contains several key components—Gateways (GW₁ 408→GWₐ 410 in the diagram), Incoming Queues (IQ₁ 412→IQ_{b} 414 in the diagram), WorkFlows (WorkFlow₁ 418→WorkFlow_{d} 420 in the diagram), Database 422, Outgoing Queues (OQ₁ 424→OQ_{c} 426 in the diagram), and an Administrator 428. It will be readily apparent to one of ordinary skill in the relevant art that numerous other components are possible within an AS 402.

A dynamically updateable set of one or more Gateways (GW₁ 408→GWₐ 410 in the diagram) handle incoming (SMS/MMS/IMS/etc. messaging, SD, etc.) traffic and outgoing (SMS/MMS/IMS/etc. messaging, SD, etc.) traffic. Incoming traffic is accepted and deposited on an intermediate or temporary Incoming Queue (IQ₁ 412→IQ_{b} 414 in the diagram) for subsequent processing. Processed artifacts are removed from an intermediate or temporary Outgoing Queue (OQ₁ 424→OQ_{c} 426 in the diagram) and then dispatched.

A dynamically updateable set of one or more Incoming Queues (IQ₁ 412 →IQ_{b} 414 in the diagram) and a dynamically updateable set of one or more Outgoing Queues (OQ₁ 424→OQ_{c} 426 in the diagram) operate as intermediate or temporary buffers for incoming and outgoing traffic.

A dynamically updateable set of one or more WorkFlows (WorkFlow₁ 418→WorkFlow_{d} 420 in the diagram) remove incoming traffic from an intermediate or temporary Incoming Queue (IQ₁ 412→IQ_{b} 414 in the diagram), perform all of the required processing operations, and deposit processed artifacts on an intermediate or temporary Outgoing Queue (OQ₁ 424→OQ_{c} 426 in the diagram). The WorkFlow component will be described more fully below.

The Database 422 that is depicted in FIG. 4 is a logical representation of the possibly multiple physical repositories that may be implemented to support, inter alia, configuration, profile, monitoring, alerting, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 428 that is depicted in FIG. 4 provides management or administrative control over all of the different components of an AS 402 through, as one example, a Web-based interface 430. It will be readily apparent to one of ordinary skill in the relevant art that numerous other interfaces (e.g., a data feed, etc.) are easily possible.

Through flexible, extensible, and dynamically updatable configuration information a WorkFlow component may be quickly and easily realized to support any number of activities. For example, WorkFlows might be configured to support a registration process; to support interactions with a SD; to support the generation and dispatch of confirmation, notification, etc. messages; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

A SP may maintain a repository (e.g., a database) into which selected details of all administrative, messaging, etc. activities may be recorded. Among other things, such a repository may be used to support scheduled (e.g., daily, weekly, etc.) and/or on-demand reporting with report results delivered (to, for example, a MS) through SMS, MMS, etc. messages; through e-mail; through a Web-based facility; etc.

It is important to note that while aspects of the discussion that was presented above focused on the use of SCs, it will be readily apparent to one of ordinary skill in the relevant art that TNs and other message address identifiers are equally applicable and, indeed, are fully within the scope of the present invention.

The discussion that was just presented referenced two specific wireless messaging paradigms—SMS and MMS. These paradigms potentially offer an incremental advantage over other paradigms in that native support for SMS and/or MMS is commonly found on a WD that a potential MS would be carrying. However, it is to be understood that it would be readily apparent to one of ordinary skill in the relevant art that other paradigms (IMS, etc.) are fully within the scope of the present invention.

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The following list defines acronyms as used in this disclosure.

| Acronym | Meaning |
|---|---|
| AS | Application Server |
| BI | Billing Interface |
| CA | Community Alarm |
| CSC | Common Short Code |
| DBMS | Database Management System |
| DVR | Digital Video Recorder |
| GW | Gateway |
| IMS | IP Multimedia Subsystem |
| IQ | Incoming Queue |
| IVR | Interactive Voice Response |
| LBS | Location Based Services |
| MICV | Messaging Inter-Carrier Vendor |
| MMS | Multimedia Message Service |
| MS | Mobile Subscriber |
| ODBMS | Oblect Database Management System |
| OQ | Outgoing Queue |
| PC | Personal Computer |
| PVR | Personal Video Recorder |
| RDBMS | Relational Database Management System |
| SC | Short Code |
| SD | Service Device |
| SMS | Short Message Service |
| SP | Service Provider |
| TN | Telephone Number |
| WC | Wireless Carrier |
| WD | Wireless Device |
| WS | Web Server |
| WWW | World-Wide Web |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the relevant art in light of the above disclosure.

What is claimed is:

1. A method for community alarming, comprising:
receiving from a Service Device an indication of an alarm condition;
performing one or more processing steps on said indication using at least in part information previously supplied by a Mobile Subscriber;
generating a notification message in view of the processed indication; and
dispatching said notification message to a Wireless Device of said Mobile Subscriber,
wherein said alarm condition is initiated by someone other than said Mobile Subscriber.

2. The method of claim 1, wherein said information is defined by a Mobile Subscriber during a registration process.

3. The method of claim 2, wherein said information includes at least one of Identifying Information, Subject Information, Contact Information, and Billing Information.

4. The method of claim 2, wherein said information is preserved through a User Profile.

5. The method of claim 2, wherein said registration process is Web-based.

6. The method of claim 2, wherein said registration process includes a billing component.

7. The method of claim 1, wherein said notification message is a SMS message.

8. The method of claim 1, wherein said notification message is a MMS message.

9. The method of claim 1, wherein said notification message contains advertising and/or promotional material.

10. The method of claim 1, further comprising:
charging a fee for notification service.

11. The method of claim 1, further comprising:
receiving a reply from said Mobile Subscriber;
processing said reply resulting in a processed reply; and
conditionally communicating with said Service Device in view of the processed reply.

12. The method of claim 1, further comprising:
dispatching another notification message to a first responder.

13. The method of claim 1, wherein said Service Device is augmented with manual or automatic control capabilities.

14. The method of claim 13, wherein said automatic control means includes voice recognition or presentation software.

15. The method of claim 1, wherein said Service Device is augmented with multimedia capabilities.

16. The method of claim 1, further comprising:
determining whether a reply has been received from said Mobile Subscriber and dispatching another notification message to another Mobile Subscriber.

17. A method comprising:
receiving information from a Mobile Subscriber during a registration process, the information including an identification of a Service Device that is operable by someone other than the Mobile Subscriber and further including a telephone number of a mobile device used by the Mobile Subscriber, and a telephone number of another mobile device used by someone other than the Mobile Subscriber;
receiving from the Service Device an indication of an alarm condition;
processing said indication using at least in part the information received during the registration process;
generating a first notification message;
dispatching said first notification message to the telephone number received as part of the information received during the registration process;
generating a second notification message; and
dispatching said second notification message to said telephone number of another mobile device used by someone other than the Mobile Subscriber.

18. The method of claim 17, wherein said first and second notification messages are SMS messages.

19. The method of claim 17, wherein said first and second notification messages are MMS messages.
